(19) United States
(12) Patent Application Publication
(10) Pub. No.: US 2008/0060993 A1
(43) Pub. Date: Mar. 13, 2008

(54) Oil filter

(75) Inventor: Kenji Yano, Hamamatsu (JP)

Correspondence Address: YOUNG & THOMPSON, 745 SOUTH 23RD STREET, 2ND FLOOR, ARLINGTON, VA, 22202, US

(73) Assignee: TOYO ROKI SEIZO KABUSHIKI KAISHA, HAMAMATSU (JP)

(21) Appl. No.: 11/892,570

(22) Filed: Aug. 24, 2007

(30) Foreign Application Priority Data
Sep. 13, 2006 (JP) 2006-247690

(51) Int. Cl. B01D 29/19; B01D 35/30

(52) U.S. Cl. 210/442

(57) ABSTRACT

An oil filter includes a base, a cap mounted to the base to be detachable and forming a filter case in association with the base, a cylindrical filter element accommodated inside the filter case, and an inner cylinder disposed inside the filter element and attached to the cap. The cap has a head portion to which an engaging member is formed so as to extend inside the filter case, an axial one end of the inner cylinder is fitted to an outside of the engaging member to be detachable. The inner cylinder is provided with a stopper projecting in a radially outward direction thereof and having a tip end abutting against an inside surface of the filter case to thereby prevent the inner cylinder from falling down, and the stopper is disposed between the head portion of the cap and the filter element.

### CROSS-REFERENCE TO RELATED APPLICATIONS

This application is based upon and claims the benefit of priority from Japanese Patent Application No. 2006-247690 filed on Sep. 13, 2006; the entire contents of which are incorporated herein by reference.

### BACKGROUND OF THE INVENTION

1. Field of The Invention

The invention relates to an oil filter to be utilized for an internal combustion engine of an automobile, for example.

2. Related Art

Generally, an oil filter is provided with a filter case and a filter element disposed inside the filter case, and the filter case is composed of a base and a cap in a sealed container form.

An oil filter of the type mentioned above, in which a filter element is accommodated inside a base, and an inner cylinder is disposed inside the filter element so as to align with an axial direction of the filter element.

A filter element has a cap. An engaging member extends downward from an inside surface of an upper end portion of the cap, and an upper end portion of an inner cylinder is fitted to and engaged with a projected outer surface portion of the engaging member to be detachable in a manner such that a space exists between the inside surface of the upper end portion of the cap and the engaging member of the inner cylinder.

Furthermore, a spring receiving portion is formed to an upper end portion of the inner cylinder, and a spring is fitted between the spring receiving portion and the inside surface of the upper end portion of the cap so that the inner cylinder is urged downward to be slidable in the axial direction thereof.

In such the oil filter, after a filter element is attached to a base, the inner cylinder, with the cap being mounted, is inserted into the filter element to thereby assemble the cap to the base.

However, at the time of inserting the inner cylinder inside the filter element, the inner cylinder may be twisted and, in an adverse case, the upper end portion of the inner cylinder may be disengaged from the engaging member.

In such an adverse case, it is necessary to again assemble the cap to the base after the mounting of the inner cylinder to the cap, which will cause a time loss in assembling the oil filter, thus being inconvenient and not effective for the manufacture of the oil filter.

Furthermore, when the inner cylinder is positioned in an inclined state in which the inner cylinder is being disengaged from the engaging member, the oil filter may not achieve its original function.

### SUMMARY OF THE INVENTION

The invention was therefore conceived in consideration of the circumstances of the prior art mentioned above, and an object thereof is to provide an oil filter having a structure easily and surely assembled.

The above and other objects can be achieved according to the invention by providing an oil filter, which comprises: a base; a cap mounted to the base to be detachable and forming a filter case in association with the base; a cylindrical filter element accommodated inside the filter case; and an inner cylinder disposed inside the filter element and attached to the cap, wherein the cap has a head portion to which an engaging member is formed so as to extend inside the filter case, an axial one end of the inner cylinder is fitted to an outside of the engaging member to be detachable, and the inner cylinder is provided with a stopper projecting in a radially outward direction thereof and having a tip end abutting against an inside surface of the filter case to thereby prevent the inner cylinder from coming down, the stopper being disposed between the head portion of the cap and the filter element.

In the above invention, the stopper may be provided with at least three projections disposed in a circumferential direction of the filter case at an equal interval.

The stopper may have a disc shape and is provided with a communication passage so that oil flows in spaces sectioned by the stopper.

According to the invention of the structures mentioned above, the oil filter is provided with a projection extending at an outer periphery of the upper portion of the inner cylinder, and the tip end of the projection abuts against the inside wall of the filter case, so that even if the inner cylinder is twisted, the inner cylinder can be prevented from coming off from the engaging member. In addition, the inner cylinder is easily and surely positioned inside the filter element. Therefore, the mounting of the cap with respect to the base can be surely performed, thus easily and surely manufacturing the oil filter.

The nature and further characteristic features of the invention will be made clearer from the following descriptions made with reference to the accompanying drawings.

### BRIEF DESCRIPTION OF THE DRAWINGS

In the accompanying drawings:

FIG. 1 is an elevational section of an oil filter according to one embodiment of the invention;

FIG. 2 is a perspective view of a structure in which an inner cylinder is engaged with an engaging member of a cap of the oil filter; and

FIG. 3 is a perspective view of a structure similar to that of FIG. 2, according to another embodiment of the invention;

### DESCRIPTION OF THE PREFERRED EMBODIMENT

A preferred embodiment of an oil filter will be described hereunder with reference to accompanying drawings, in which the oil filter is applied to an engine of an automobile. It is further noted that terms “upper”, “lower”, “right”, “left” and the like terms are used herein in an illustrated state in the drawings or an actually installed state of the oil filter.

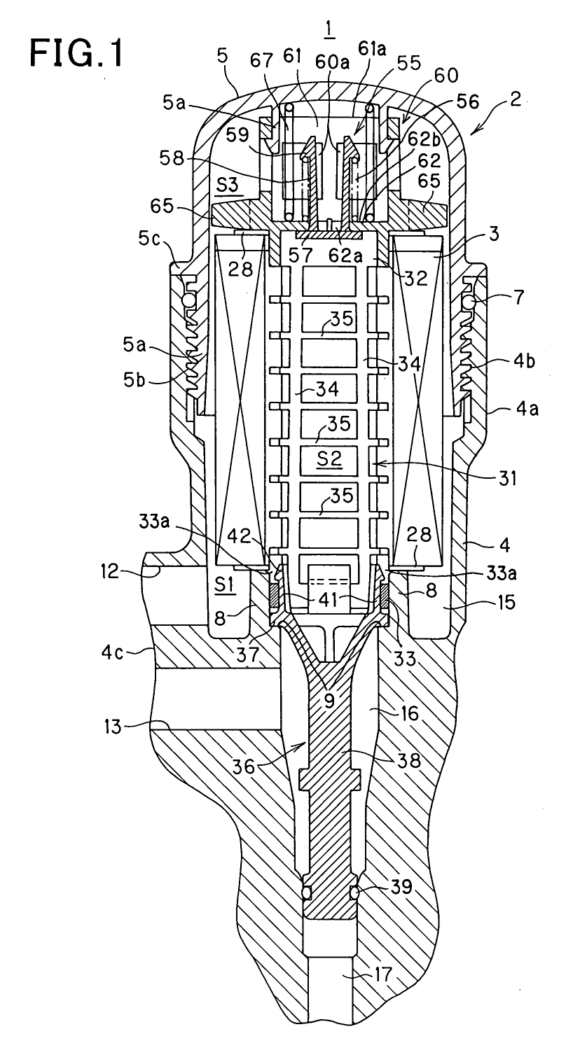

With reference to FIG. 1, an oil filter 1 is provided with a filter case 2 and a filter element 3 accommodated inside the filter case 2. The filter case 2 is composed of a base 4 and a cap 5, which are assembled in a sealed container shape.

The base 4 is provided with a circular cylindrical member (cylindrical portion) 4a, which is formed, in its inner peripheral surface, with a female screw portion (threaded portion) 4b which is engaged with a male screw portion (threaded portion) 5b formed to a tip (front) end side of a fitting portion 5a of the cap 5. According to such engagement, the cap 5 and the base 4 are coupled together.

The fitting portion 5a of the cap 5 is formed so as to extend downward from an inside surface of a top end portion of the cap 5. An O-ring 7 is fitted, as sealing means, on an outer periphery of the fitting portion 5a of the cap 5, and the O-ring 7 contacts closely to the inner periphery of the cylindrical portion 4a to thereby seal the joining portion between the cap 5 and the base 4. The cap 5 is provided with a flanged portion 5c formed to a side portion thereof, and when the cap 5 is applied, the flanged portion 5c abuts against a top end surface of the cylindrical portion 4a of the base 4 so as to position the cylindrical portion 4a in its axial direction.

The base 4 is provided with an inlet port 12 and an outlet port 13 which are opened, in one ends, to an mounting surface 4c and extend, in the other ends, in a direction perpendicular to the axis of the cylindrical portion 4a. When the base 4 is coupled to, for example, an engine block of an automobile, this mounting surface 4c closely contacts the joining surface to the engine block, the inlet port 12 is connected to a discharge port of an oil from the engine, and the outlet port 13 is connected to a supply port communicating with a lubricating position of the engine.

Furthermore, inside the base 4, a fitting cylindrical portion 8 is formed to be coaxial with the cylindrical portion 4a of the base 4, and an oil introducing passage 15 communicating with the inlet port 12 is formed in an outer peripheral surface of the fitting cylindrical portion 8. An oil supply passage 16 serving as an oil passage is also formed to the lower portion of the fitting cylindrical portion 8 so as to communicate with the outlet port 13 and extend downward in alignment with the axis of the cylindrical portion 4a. In addition, the fitting cylindrical portion 8 has an inner diameter of an opening thereof slightly larger than an inner diameter of the oil supply passage 16. The inside of the fitting cylindrical portion 8 communicated with the oil supply passage 18 through a stepped portion 9. On the other hand, the oil introduction passage 15 is formed to the base 4 as an annular groove surrounding the oil supply passage 16.

Further, a drain passage 17 is formed below the oil supply passage 16 so as to extend in the axial direction of the cylindrical portion 4a in alignment with the axial direction of the oil supply passage 16. The drain passage 17 communicated with the oil supply passage 16 so as to discharge outside an oil in the filter case 2. The drain passage 17 also communicated with an oil pan and the like.

The filter element 3 accommodated in the filter case 2 is formed from a filter material such as filter paper by bending it in form of pleat having crests and roots in an alternating manner in a circumferential direction thereof so as to entirely provide a cylindrical shape. Seal plates 28, 28 are joined to both axial end portions of the filter element 3 by means of bonding agent, for example. The seal plate 28 is formed from a material having a filtering property such as filter material mentioned above, for example, filter paper or unwoven fabric. The filter element 3 is disposed in alignment with the axis of the cylindrical portion 4a of the base 4.

An inner cylinder 31 is fitted inside the filter element 3, and an inner cylinder extension 36 is assembled to the lower end of the inner cylinder 31 so as to be movable with respect to the inner cylinder 31 in the axial direction of the cylindrical portion 4a. The inner cylinder extension 36 has an upper end portion engaged with the stepped portion 9, and a portion extending from this upper end portion is inserted into the oil supply passage 16. A portion at which the inner cylinder 31 and the inner cylinder extension 36 are assembled is fitted inside the fitting cylindrical portion 8 and then held thereby. These inner cylinder 31 and the inner cylinder extension 36 are mold products formed of resin material or like.

The inner cylinder 31 is provided with a pair of vertically extending cylindrical portions 32 and 33, a plurality (for example, four) of vertical ribs extending in the axial direction so as to connect the cylindrical portions 32 and 33, and a plurality of ring-shaped transverse ribs 35, . . . , 35 arranged between the cylindrical portions 32 and 33 with equal interval.

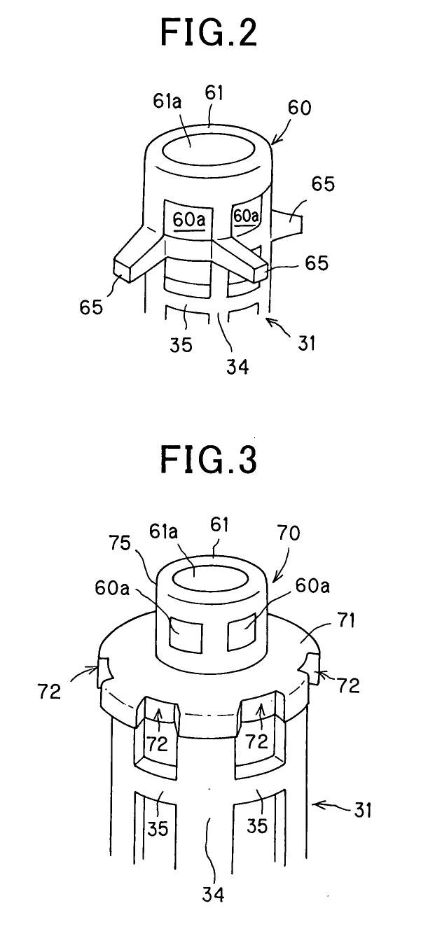

As shown in FIGS. 1 and 2, an engaging member 60 is formed to an upper portion of the inner cylinder 31 so as to be engaged with the cap 5. The engaging member 60 has substantially a cylindrical shape, and is provided, at its upper end portion 61, with a through hole 61a. The upper end portion 61 of the engaging member 60 is fitted to an outside of the pawl portion 5a of the cap 5 extending form the head portion of the cap 5 toward the inside of the filter case 2 through the through hole 61a. The pawl portion 5a is formed of an elastically deformable material, and the front end of the pawl portion 5a is displaceable with respect to the base end portion in the radial direction of the through hole 61a.

When the pawl portion 5a is elastically deformed and the front end thereof is engaged with or released from the upper end portion 61 of the engaging member 60, the cap 5 and the engaging member 60 may be engaged with or disengaged from each other. According to this structure, the inner cylinder 31 is assembled to the cap 5 at one-touch operation, thus easily assembling the cap 5 and the inner cylinder 31 together.

In addition, four projections 65 are formed to the lower portion of the engaging member 60 so as to extend radially outward. The projections 65 are arranged between the head portion of the cap 5 and the filter element 3 and serves as a stopper to prevent the inner cylinder 31 from being twisted and inclined.

In the oil filter 1 of the structures mentioned above, it is possible to assemble the inner cylinder 31 to the cap 5 without being inclined by the formation of the projections 65. When the inner cylinder 31 is inserted into the inside of the filter element 3 and the cap 5 is assembled to the base 4, the twisting and inclining of the inner cylinder 31 can be effectively prevented.

Furthermore, it is possible to easily and surely position the inner cylinder 31 inside the filter element 3. Accordingly, the cap 5 can be surely mounted to the base 4, and the oil filter 1 is thus easily and surely manufactured.

Further, the number of the projections 65 is not limited to “four” and at least three projections 65 may be required for mounting the inner cylinder 31 to the cap 5 along the axis of the filter case without being inclined.

Each of the projections 65 has a lower surface abutting against a seal plate 28 so as to press down the filter element 3. More specifically, when the inner cylinder 31 is inserted into the cylindrical portion 4a with the inner cylinder 31 being mounted to the cap 5, and under this state, screwed into the base 2, the lower surface of the projection 65 closely contacts the seal plate 28 and the filter element 3 is then pushed into the cylindrical portion 4a in the axial direction thereof. As a result, the filter element 3 is held between the end face of the fitting cylindrical portion 8 and the projection 65, and is coaxially positioned with the cylindrical portion 4a. Accordingly, the inner and outer peripheral sides of the filter element 3 are liquid-tightly sealed to thereby section the interior of the filter case into dirty sides S1 and S3 and a clean side S2.

Furthermore, a spring receiving portion 62 is formed inside the lower end of the engaging member 60, and a spring 67 is disposed between this spring receiving portion 62 and the head of the cap 5. Accordingly, the inner cylinder 31 is urged downward so that the inner cylinder 31 is movable in the axial direction of the filter case.

A through hole 62a is formed to a central portion of the spring receiving portion 62, and a relief valve 55 is disposed in this through hole 62a. The relief valve 55 is movable in the axial direction of the cylindrical portion 4a, and includes a valve body 57 abutting against the lower end opening of the through hole 62a, a valve body supporting member 58 extending upward through the inner peripheral surface of the through hole 62a, a pawl portion 59 formed to the tip end of the valve body supporting member 58, and a coil spring 56 disposed between the pawl portion 59 and the spring receiving portion 62 so as to urge the valve body 57 against the lower end opening of the through hole 62a. When the through hole 62a is closed by the valve body 57 and a pressure in the clean side S2 increases over a predetermined value, the valve body 57 is separated from the engaging member 60 and the through hole 62a is opened so as to escape the pressure from the dirty side S3 to the clean side S2.

Further, the pawl portion 5a of the present embodiment functions as an engaging member fitted to a valve seat and the projection 65 of the present embodiment functions as a stopper for preventing the inner cylinder 31 from coming down or tilting downward.

On the other hand, the inner cylinder extension 36 is provided with an engaging member 37 disposed to an outer periphery of the upper end thereof so as to be engaged with the stepped portion 9 and a support shaft 38 extending in the axial direction of the cylindrical portion 4a. An O-ring 39 is fitted, as sealing means, to the outer periphery of the lower end portion of the support shaft 38, and the O-ring 39 closely contacts the inner periphery of the lower end portion of the oil supply passage 16.

According to the structure mentioned above, the oil supply passage 16 does not usually communicate with the drain passage by the tight arrangement of the O-ring 39, however, at the time of exchanging the filter element 3, the inner cylinder extension 36 is withdrawn upward, so that the oil supply passage 16 and the drain passage 17 communicated with each other. At this time, the oil stored inside the filter case is returned to an oil pan through the drain passage 17.

Furthermore, a sliding (slidable) member 41 is formed to the upper end portion of the inner cylinder extension 36 so as to extend upward along the axis of the inner cylinder 31 and to be slidable along the inner peripheral surface of a cylindrical portion 33 formed to the lower end portion of the inner cylinder 31. The sliding member 41 has a pawl portion 42 at its tip end portion, and this pawl portion 42 is positioned in a groove 33a formed above the cylindrical portion 33 and is engaged with the upper end portion of this cylindrical portion 33 so as to prevent them from coming off in the axial direction of the cylindrical portion 4a.

The upper end portion of the inner cylinder extension 36 has a circular shape, and a plurality of sliding members 41 are formed in the circumferential direction thereof. The inner peripheral surface of the cylindrical portion 33 is fitted to the outer periphery of the sliding members 41.

Furthermore, the cylindrical portion 33 is held to be movable between the upper end portion of the engaging portion 37 formed to the inner cylinder extension 36 on the lower end side of the sliding member 41 and the pawl portion 42 formed to the upper end of the sliding member 41 in a manner capable of restricting the movement thereof. Likely, the movement of the inner cylinder extension 36 is also restricted. Further, the pawl portion 42 and the engaging portion 37 serves as stopper for restricting the movement of the inner cylinder 31 and the inner cylinder extension 36.

The thus formed inner cylinder 31 and the inner cylinder extension 36 are movable in the axial direction of the cylindrical portion 4a by the mutual sliding motion between the cylindrical portion 4a of the inner cylinder 31 and the outer periphery of the sliding members 41 formed to the inner cylinder extension 36.

Each of the sliding members 41 is formed of an elastically deformable material, and the front end thereof is deformable in a radial direction of the cylindrical portion 33 with respect to the base end thereof. When the pawl portion 42 formed to the front end of the sliding member 41 is elastically deformed and engaged with the upper end portion of the cylindrical portion 33 while being disposed in the groove 33a formed above the cylindrical portion 33, the inner cylinder 31 and the inner cylinder extension 36 becomes detachable. According to such structure, the inner cylinder extension 36 can be easily assembled to the inner cylinder 31 in one-touch assembling operation.

In the oil filter 1 of the present embodiment of the structure mentioned above, the inner cylinder 31 and the inner cylinder extension 36 are assembled to the cap 5 through the engaging member 60 and then inserted into the base 2 together with the filter element 3, and thereafter, the cap 5 is screwed in till the flanged portion 5c of the cap 5 abuts against the cylindrical portion 4a of the base 4, thus completing the oil filter 1 of the structure shown in FIG. 1.

In the assembled state shown in FIG. 1, the inner cylinder extension 36 inserted into the base 4 is pressed downward into the deep side (i.e., lower side on the drawing) of the oil supply passage 16, and as a result, the drain passage 17 is closed. In addition, the assembled portion of the inner cylinder 31 and the inner cylinder extension 36 is fitted to the fitting cylinder 8, and the inner cylinder 31 is positioned inside the filter element 3.

At this time, even if the inner cylinder 31 is twisted, the inner cylinder 31 can be prevented from tilting in the axial direction of the filter case 2 and is assembled with the cap 5. Thus, the engaging member 60 can be also prevented from coming off from the pawl portion 5a of the cap 5, thereby easily and surely assembling the cap 5 with respect to the base 4, and therefore, the oil filter 1 can be easily and surely manufactured.

Hereunder, another embodiment of the engaging member will be explained with reference to FIG. 3 of a perspective view, in which like reference numerals are added to elements or portions corresponding to those shown in FIGS. 1 and 2, and their explanations are omitted herein.

As shown in FIG. 3, an engaging member 70 of this embodiment is formed with a disc-shaped projection 71 projecting outside in the radial direction of an entire periphery of the cylindrical portion 75 at its lower portion, and the front end portion of the projection is provided with a notches 72 at predetermined interval. In such structure, the engaging member 70 differs from the engaging member 60 of the former embodiment shown in FIG. 2.

The engaging member 70 includes a cylindrical portion 75 and a projection 71 projecting outward integrally from the lower end of the cylindrical portion 75 so as to extend in the entire radial outward direction thereof. A communication passage is formed to an outer periphery of the front end portion of the projection 71 so that an oil flows between spaces sectioned vertically by the projection 71. More specifically, the notches 72 are formed at the predetermined interval in the outer peripheral direction of the front end portion of the projection 71.

Further, a through hole 61a is formed to the upper end portion 61 of the engaging member 70, and this upper end portion 61 is fitted, through the through hole 61a, to the outer side of the pawl portion 5a extending inward of the filter case 2 from the head portion of the cap 5 to be detachable.

Furthermore, a spring receiving portion 62 is formed inside the engaging member 70, and a spring 67 is disposed between the spring receiving portion 62 and the head portion of the cap 5. A through hole 62a is formed to the central portion of the spring receiving portion 62, and a relief valve 55 is disposed in the through hole 62a.

The projection 71 of the present embodiment functions as a stopper for preventing the inner cylinder from coming down, and the notches 72 of this embodiment functions as communication passages through which the oil flows in the spaces sectioned by the stopper.

In the oil filter of the structure mentioned above, the inner cylinder 31 is assembled with the cap 5 without inclining in the axial direction of the filter case 2, so that when the inner cylinder 31 is inserted inside the filter element 3 and assembled with the cap 5 with respect to the base 4, the inner cylinder 31 can be prevented from twisting and tilting (coming down), and the inner cylinder 31 can be easily and surely assembled with the cap 5 with respect to the base 4, thus easily and surely manufacturing the oil filter 1.

It is to be noted that the invention is not limited to the described embodiments and many other changes and modifications may be made without departing from the scopes of the appended claims.

For example, the oil filter of the invention is applicable as a filter for filtrating hydraulic oil of an automatic transmission as well as engine oil of an automobile. In addition, in the described embodiment, although the notches 72 are formed to the projection 71 of the engaging member 70, a through hole vertically penetrating the projection 71 may be formed in place of the notches 72.

Although the invention has been described above by reference to certain embodiments of the invention, the invention is not limited to the embodiments described above. Modifications and variations of the embodiments described above will occur to those skilled in the art, in light of the above teachings. The scope of the invention is defined with reference to the following claims.

What is claimed is:

1. An oil filter comprising:
a base;
a cap mounted to the base to be detachable and forming a filter case in association with the base;
a cylindrical filter element accommodated inside the filter case; and
an inner cylinder disposed inside the filter element and attached to the cap,
wherein the cap has a head portion to which an engaging member is formed so as to extend inside the filter case, an axial one end of the inner cylinder is fitted to an outside of the engaging member to be detachable, and the inner cylinder is provided with a stopper projecting in a radially outward direction thereof and having a tip end abutting against an inside surface of the filter case to thereby prevent the inner cylinder from coming down, the stopper being disposed between the head portion of the cap and the filter element.

2. The oil filter according to claim 1, wherein the stopper is provided with at least three projections disposed in a circumferential direction of the filter case at an equal interval.

3. The oil filter according to claim 1, wherein the stopper has a disc shape and is provided with a communication passage so that oil flows in spaces sectioned by the stopper.
